(19) United States
(12) Patent Application Publication
(10) Pub. No.: US 2012/0038489 A1
(43) Pub. Date: Feb. 16, 2012

(54) SYSTEM AND METHOD FOR SPONTANEOUS P2P COMMUNICATION BETWEEN IDENTIFIED VEHICLES

(76) Inventor: Ehud GOLDSHMIDT, Shoham (IL)

(21) Appl. No.: 12/855,453

(22) Filed: Aug. 12, 2010

(51) Int. Cl. G08G 1/16; G08G 1/00; H04W 4/04; G06F 17/00

(52) U.S. Cl. 340/903; 701/300; 340/902; 370/338

(57) ABSTRACT

System and method are presented which allow a user of a vehicle to initiate a spontaneous call to a nearby vehicle without knowing the phone number, or any other specific contacting details of the nearby vehicle, based on identification signs of the nearby vehicle which are visible to the user of the first vehicle, such as the color of the nearby vehicle, the model and the manufacturer of the vehicle. The system comprising communication means for establishing ad-hoc network communication with the nearby vehicle and display for displaying indications of the visible identification signs to that user.

### BACKGROUND OF THE INVENTION

Many vehicles which travel on the roads are equipped today with one or more mobile communication devices, such as cellular mobile phones, global positioning system (GPS), wireless network transmitter/receiver, satellite based phones, etc. When traveling, either along highways, country side roads or off-road, there may be required an ability to spontaneously initiate a call to a nearby other vehicle the identity (or calling number) of its driver or of the built-in mobile communication device are unknown to the call initiator, based on substantially only an outside visible identity details, such as the model of the vehicle, the color of the vehicle, the vehicle's license plate number, etc.

### SUMMARY OF THE INVENTION

The present invention may comprise a system installed on a vehicle comprising a processor comprising a memory unit to store a set of visible identification signs associated with said vehicle and calling details for calling said vehicle, a short range communication unit to enable participation in ad-hoc communication network, a display unit and input means, wherein said communication unit is adapted to transmit indication of said visible identification signs to other participants in said ad-hoc communication network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a group of vehicles during motion with communication between some of them, according to embodiments of the present invention;

FIG. 2A which schematically illustrates communication system installed in a vehicle for enabling spontaneous communication of a driver of the vehicle with a driver of another vehicle, according to embodiments of the present invention;

FIG. 2B which schematically illustrates a plurality of vehicles, each is equipped with a communication system according to embodiments of the present invention;

FIG. 3A, which schematically presents a screen of the display of a communication system, according to embodiments of the present invention;

FIG. 3B which schematically presents another screen of the display of the communication system, according to embodiments of the present invention; and

FIG. 4 is a schematic flow diagram of communication initiation and maintaining according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A driver traveling in a car may be interested to communicate with a driver of a nearby other vehicle, for example for warning the other driver from an obstacle on the way, for receiving update of a traffic jam the other driver may have noticed, or any other reason. However, usually a traveling driver does not know how to contact another driver if the number of the mobile phone (such as a cellular phone) of that other driver is not known to him by chance. Usually a second vehicle in short a distance from a traveling first driver may be identified by the first driver by one or more visible signs. The short distance may be, for example, a distance enabling the traveling driver of the first vehicle to identify one or more details of the second vehicle from a list of visible identifying details, such as the color of the vehicle, the vehicle's model, the vehicle's production year, the vehicle's license plate string of characters, etc. At least some of the vehicles may be equipped with a mobile communication transceiver, such as a cellular phone, a Bluetooth transceiver, wireless local area network transceiver, such as a wireless network operating based on IEEE 802.11 standard, such as wireless fidelity (WiFi) wireless network of WiFi Alliance ®, and the like. According to embodiments of the present invention two or more vehicles being in a distance between them which allows establishment of an ad-hoc local area communication network and further allows perception of visible identification signs of one vehicle by the driver of the other vehicle may establish an ad-hoc local area communication network between them.

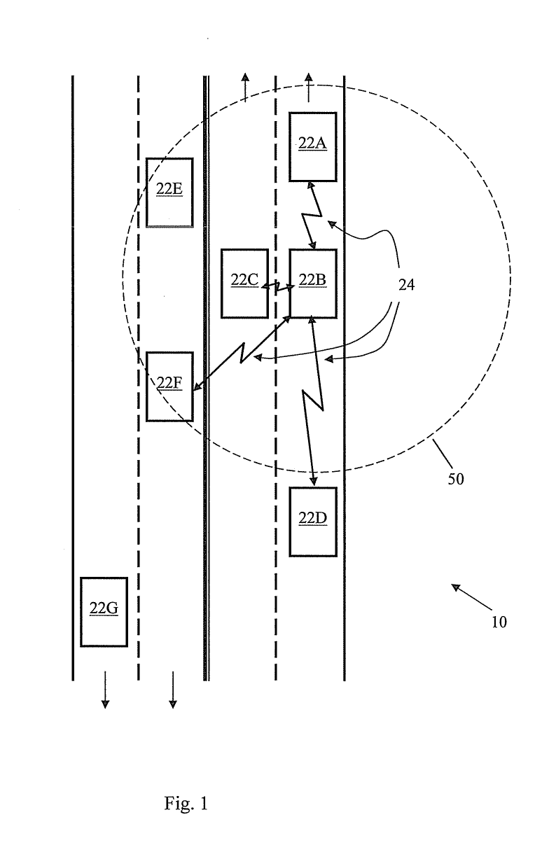

Reference is made now to FIG. 1, which is a schematic illustration of a group 10 of vehicles during motion with communication between some of them, according to embodiments of the present invention. Group 10 of vehicles may comprise a variable number of members. Group 10 depicted in FIG. 1 consists of vehicles 22A-22G, however, since the membership in group 10 is spontaneous and based on the momentary and dynamic nature of traffic, group 10 of vehicles may comprise, at any given time, smaller or larger number of members. At least some members in group 10 may be equipped with transceiver enabling the engagement to a wireless ad-hoc network, such as Wireless Fidelity (WiFi) of WiFi Alliance, Worldwide Interoperability for Microwave Access (WiMax) based on the IEEE 802.16 standard, ZigBee based on IEEE 802.15.4 standard, etc. where the network has the capability to recognize newly joined members based on the protocol and add them automatically. The wireless ad-hoc communication network according to embodiments of the present invention may be of a kind limited to relatively short ranges. For example, the range of a wireless ad-hoc network according to embodiments of the present invention may be limited to a range which still allows a driver of one of the group's vehicles to perceive visible identifying (VID) indications of another vehicle in the group, for example—about 150-200 meters in case when the color and model of the other vehicle are to be perceived, and about 100 meters or less if the license plate writing is to be perceived.

As presented in FIG. 1, vehicles 22A, 22B, 22C and 22F may be engaged in a wireless ad-hoc communication network 24, while vehicles 22D, 22E and 22G are not engaged in this wireless ad-hoc communication network. The imaginary circle 50 drawn around vehicle 22B exemplifies a range measured from vehicle 22B within which the driver of vehicle 22B may have visible perception of certain VID indications of vehicles around it. It will be apparent to a person skilled in the art that this range may vary, depending upon factors such as the driver's vision, visibility conditions, noticeability (such as level of contrast of the ID sign versus the background), etc. Further, the shape of the closed line encircling the area in which a driver of vehicle 22B may perceive VID signs of other vehicles around him may be other than a circle, mainly due to the changes in visibility around the vehicle compared to the visibility in the looking-forward sector, and possibly due to other factors. For example, a driver may have lower visibility at the back of the vehicle compared to that of the looking-forward.

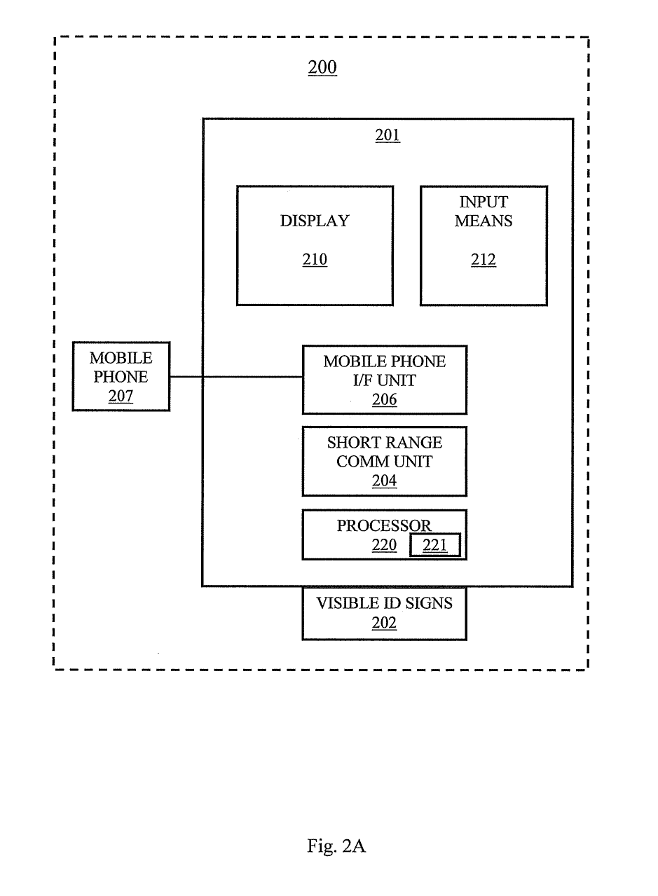

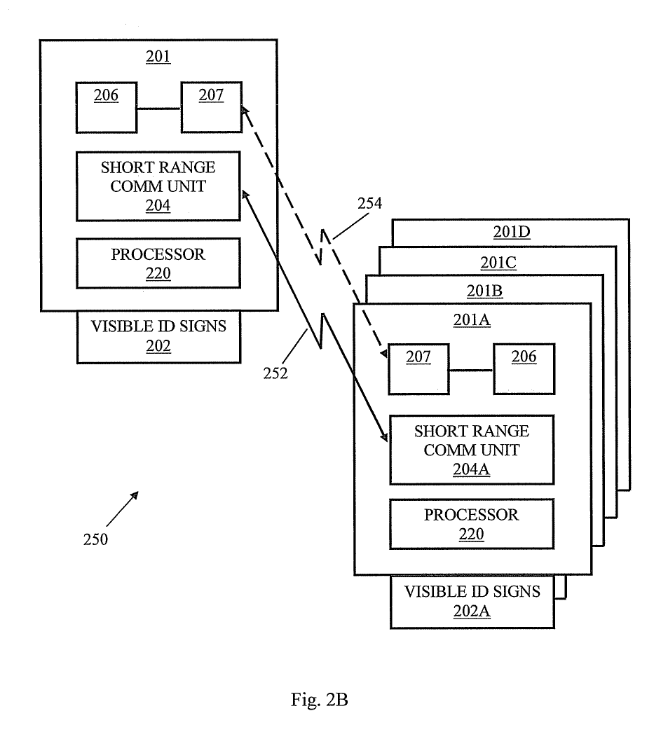

Reference is made now to FIG. 2A, which schematically illustrates communication system 201 installed in a vehicle 200 for enabling spontaneous communication of a driver of vehicle 200 with a driver of another vehicle, according to embodiments of the present invention. Communication system 201 may comprise a short range communication unit 204, capable of engaging and participating in a wireless ad-hoc communication network as described above, in ranges of at least 200 meters; display 210 for presenting data to a user, such as the driver of vehicle 200; input means 212 enabling the user to input data and/or commands to communication system 201; and processor 220 with memory 221 to control the operations of communication system 201. Processor 220 may be a CPU, a controller or any other device capable of executing programs for performing the functions of communication system 201, of communicating with peripheral devices such a storage device (not shown) and of communicating with short range communication unit 204, with mobile phone interface unit 206, with display 210 and with input means 212. According to some embodiments of the present invention display 210 and input means unit 212 may be realized in one physical unit, such as a touch screen. Mobile phone interface unit 206 is adapted to communicate with mobile phone 207, initiate a call to a selected phone number provided by, or pointed at by interface unit 206, hold a call, deny an incoming call, etc.

Communication system 201 may is uniquely associated with VID signs 202 of vehicle 200. VID signs unit 202 is a general definition for a set of available visible ID signs that vehicle 200 has. While most (if not all) vehicles have certain visible ID features such as color, manufacturer model, license plate characters string, etc., some of these vehicles may have additional/other visible signs such as a decorative spoiler, roof rack, rear bike carrier and the like. Some of the vehicles may also be equipped with short range communication unit capable of engaging and participating in wireless ad-hoc communication network. According to embodiments of the present invention VID signs 202 of vehicle 200 are stored in a storage means in communication system 201 and may be transmitted to other participants of the wireless ad-hoc communication network. For example: vehicle 200 has VID signs 202 set such as red color, manufactured by Chevrolet® with license plate string “ABC 123”. These VID signs 202 are uniquely associated with communication system 201 of vehicle 200 and their description is stored in system 201. According to embodiments of the present invention another vehicle participating in wireless ad-hoc communication network with which communication system 201 is engaged will receive an indication that a red Chevrolet® vehicle with a license plate reading “ABC 123” is currently a member of the wireless ad-hoc communication network.

A mobile phone 207 of vehicle 200, or of a driver of vehicle 200, may be associated with and in active communication with communication system 201, for example via mobile phone interface unit 206. In some embodiments mobile phone 207 may be part of communication system 201.

Reference is made now also to FIG. 2B, which schematically illustrates a plurality of vehicles, each is equipped with a communication system 201, 201A . . . 201D, etc., according to embodiments of the present invention. These communication systems are installed in vehicles denoted 200, 200A . . . 200D, etc. respectively (not shown). Two or more vehicles may be engaged in wireless ad-hoc communication network 252. Each vehicle which is linked into wireless ad-hoc communication network 252 transmits to all other participants its VID signs description as identified in VID signs 202 indications and recorded in the storage device of processor 220. Each vehicle which is linked in wireless ad-hoc communication network 252 receives the ID indications of the other vehicles presently linked to wireless ad-hoc communication network 252. The linked vehicles may be presented to a user of communication system 201 on display unit 210. The indication of the other linked vehicles is done by presenting to the user the available VID details, such as, according to the example above, “Red Chevrolet, ABC 123”. User of communication system 201 may associate a set of ID details with a specific name SN and save this SN in the storage device of system 201. Received VID details for which a SN is saved in the system will be presented to the user by presenting SN instead of, or additional to the set of VID details. For example, if user of communication system 201 has associated the name Dan with the ID details “Red Chevrolet, ABC 123”, then each time the communication system associated with these ID details, for example communication system 201C, links to wireless ad-hoc communication network 252, other members which are linked to that network will receive indication that communication system identified as “Red Chevrolet, ABC 123” is connected to the network, and communication system 201C will also get indication that this communication system is identified as “Dan”.

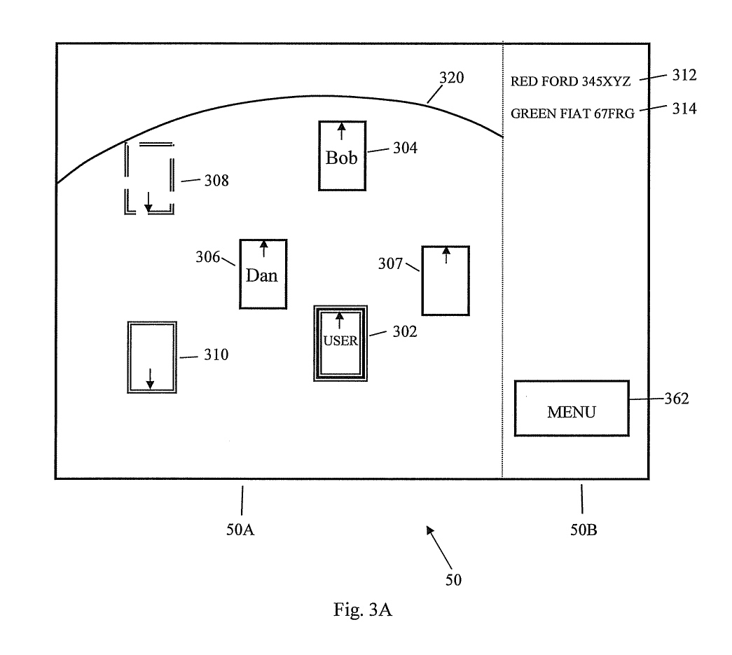

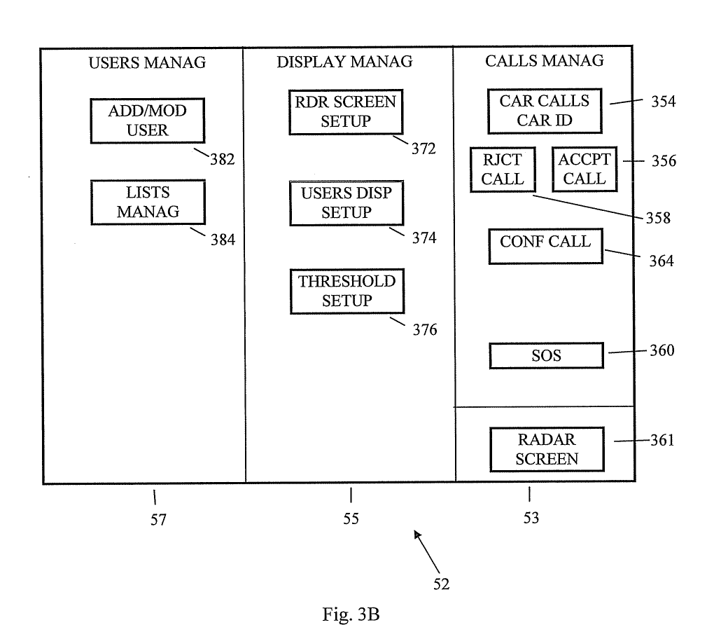

As is depicted in FIG. 2B, communication systems 201-201D are adapted to initiate and maintain mobile phone connections, such as cellular connection, between two or more members of network 252. For example, two or more of communication systems 201-201D may communicate via a wireless telephone network 254. This feature is discussed in details in connection with FIGS. 3A and 3B. It will be noted that in case mobile phones 207, 207A, etc. support establishment of conference call between them, mobile interface unit 206 will be adapted to establish and administer that conference call when needed.

According to some embodiments wireless ad-hoc communication network may provide indications of relative distance between members in the network, and according to additional embodiments it may also provide indications of relative direction between members in the network. System 250, by means of relying on Global Positioning System (GPS) information or on TOA (Time of arrival) techniques using, for example, parallel transmissions in two different frequencies, may calculate the distance of another member in network 252 from the vehicle of systems 201. According to embodiments of the present invention vehicle 200 may use an antenna having multi-directional resolution capability to enable receipt of indications of the relative direction form which a transmission from another member in the ad-hoc network is received. When both relative or absolute distance and relative or absolute direction between vehicle 200 with system 201 and another member linked to ad-hoc network 252 are available, the location of the other member or members, in absolute or relative notations may be calculated and used, for example, for presenting to the user of system 201.

The information transmitted from one member of ad-hoc network 252 to other member or members may include location indication, such as geographical coordinates that may be received from a GPS receiver which is in active communication with system 201, and the like. Location information of members in ad-hoc network 252 may be used to graphically present the relative location of other members with respect to the location of vehicle 200 (with system 201) on display unit 210. According to embodiments of the present invention this information may further be parsed to deduct and present, for example on display unit 210, relative movement of the other members in ad-hoc network 252 with respect to vehicle 200. Further, system 201 may analyze these relative movements and identify specific movements of special interest to the user of vehicle 200, such as movements with high probability to cause an accident. System 201 may have stored in its storage device envelopes of distance, relative direction and closing speed which may represent high risk of accident and may further issue warnings to the user when a risky situation is evolving. According to yet other embodiments of the present invention system 201 may disregard, for the sake of issuance of alarms, member vehicles traveling in direction opposite to that of vehicle 200 for example on roads having barrier between the lanes of the separate travel directions because on such roads approaching vehicle may, most probably, be traveling on a lane on the other side of the bather and thus imposing no risk. Collision alerts may be issued when the combination of distance and closing speed and direction between user of vehicle 200 and another vehicle member exceeds a defined threshold, such as the “2 seconds” threshold applying to a minimum distance that leaves at least two seconds for the driver to react in emergency braking situation.

Reference is made now to FIG. 3A, which schematically presents screen 50 of display 210 of communication system 201, and to FIG. 3B which schematically presents screen 52 of display 210 of communication system 201, according to embodiments of the present invention. Screen 50 may comprise two main display areas 50A and 50B. Display area 50A may be used to graphically present location information related to members who are currently linked to communication network 252, relatively to the location of a graphical representation of vehicle 200 of the user. Members who are linked to ad-hoc communication network 252 may have one or more of several features, such as: members identified by their name, members supporting indication of relative distance, members supporting indication of relative direction, members whose request to establish a phone call with vehicle 200 was refused, members who are in active phone connection with the user of vehicle 200, etc. Some of these features may be graphically presented on screen 50A, as will be discussed below. Display screen 50A may present icon 302 which graphically represents vehicle 200 (22B of FIG. 1) of the user of system 201; icon 304 may graphically represent vehicle 22A of FIG. 1; icon 306 may graphically represent vehicle 22C of FIG. 1, icon 308 may graphically represent vehicle 22E of FIG. 1 and icon 310 may graphically represent vehicle 22F of FIG. 1. Icons 304 and 306 may have different appearance then icon 302 and may be used to graphically present vehicles for which a SN is associated with their respective VID signs and is saved in system 201, for example “Bob” and “Dan” respectively. Accordingly, the SN “Bob” and “Dan” will be presented in association with the icon on screen 50A representing the respective members in ad-hoc network 252. In some embodiments the written description of the VID signs of the vehicles of Bob and of Dan may also be presented next to their SNs. Icon 308 may have yet another visible feature to represent the fact that it's distance from vehicle 200 of the user is beyond the distance enabling to identify its VID signs, in case communication system 250 supports measurement of distances. The distance governing this feature may be definable by the manufacture of system 201 and/or by the user of system 201. According to embodiments of the present invention this threshold distance may vary according to the relative angle of line of sight from vehicle 200 to the vehicle represented by icon 308, by visibility conditions, etc. Icon 310 may have yet another visible feature to represent a vehicle participating in wireless ad-hoc communication network 252 but its visible ID signs are not associated with any SN saved in system 201. It would be noted that in display 50A some visible features are exemplified using different types of lines other visible features may be used, such as color of the icon, color of the fill of the icon, and the like.

When system 250 supports obtaining distance and direction between participating vehicles, the location of icons representing participating vehicles on display area 50A of screen 50 with respect to icon 302 may be representative and correlative to the distance and direction of the respective vehicles with respect to vehicle 200. Icon 302 may be presented substantially in the middle of display area 50A, or at any other desired location, such as is the case in FIG. 3A, where icon 302 is presented substantially at ⅓ of the height of display area 50A from the bottom and slightly to the right of the middle of width of display area 50A, to represent travel on a right lane. According to embodiments of the present invention several presentation modes may be used, such as “nose-up” in which the location and orientation of icon 302 in display area 50A is fixed and other graphical icons and other graphical data, e.g. moving map (when supported) will be moved and/or panned accordingly; “north-up” in which icon 302 may be located in the middle of display area 50A and its orientation is changed on the screen to represent the deviation of the direction vector of movement of vehicle 200 from the North, etc. When system 250 does not support indications of distance and direction between participating vehicles, their respective icons may be presented in display area 50B, for example as a list comprising VID descriptions 312 and 314 in any desired order and manner, with respect to each other.

Display area 50A may further present a calculated border line 320 vehicles which are presented on the far side of it from icon 302 are supposed to have poor connection on ad-hoc network 252, or none at all. Display screen 50 may be designed to reflect, similarly to “traditional” radar screens, the relative location and speeds of vehicle 200 represented buy icon 302 with respect to other vehicles currently engages in communication on ad-hoc network 252. Changing the content displayed on the screen may be done by pressing on “Menu” soft key 362, in case display 210 is a touch screen, or on a dedicated hard key close to the screen. Pressing this button will change the display and functionality of the screen from graphical presentation of the relative location of vehicle 200 to neighboring vehicles (the “Radar” screen), to presentation of functional screen 50B, as depicted in FIG. 3B. Switching from Display screen 50 to 52 may be done manually by pressing “Menu” button 362 or automatically, in response to a triggering event. A triggering event may be, for example, an incoming phone call.

When the display of system 201 is in the “Radar” display mode, as depicted in FIG. 3A, and the user in vehicle 200 wishes to initiate a phone call with one of the vehicles participating in wireless ad-hoc communication network, he may simply touch the icon on display area 50A associated with that vehicle. If the vehicle with which the user wishes to initiate a call is not associated with a SN, the user may identify that vehicle by the list of VID signs available to system 252 which are presented next to the icon of that vehicle. This feature actually allows a driver of a first vehicle to initiate a call to a driver of a second vehicle within the reach of his sight, based only on outside VID signs of the second vehicle, without needing to know who drives that second vehicle or what is his/her mobile phone number, as long as the second vehicle has linked to the wireless ad-hoc communication network and his communication system for participating transmits the VID signs of its vehicle. According to embodiments of the invention the user may initiate a call to a participating vehicle simply by pressing on the graphical symbol of that vehicle on his screen, or by pressing/activating a respective input means. It will be appreciated by a person skilled in the art that for supporting this feature of spontaneously calling a participating vehicle there is no need for an external database which stores tables of potential participant vehicles and their respective mobile phone numbers, or nay other external database. System and method of the present invention enable initiating a call to a completely stranger vehicle based solely on the external visible ID signs of that vehicle.

Display screen 52 may be used for the presentation, activation and administering of functions, warnings and other interface items of system 251 with the user and with other vehicles currently engaged in ad-hoc network 252. Display screen 52, and if necessary display screens that are accessible via display screen 52 (not shown), may enable display, activation and control of phone calls and specifically incoming calls. When a user in a vehicle engaged in ad-hoc network 252 calls system 201 the user in vehicle 200 may handle the call via function buttons located in portion 53 of display screen 52. The switching from “Radar” screen 50 to display screen 52 may be carried out automatically or manually, as described above in details. When display screen 52 is activated an incoming call will be indicated by the displaying of CAR CALLS icon 354 along with ID of the calling member of the ad-hoc network. When the calling member is a known user in system 201 and has been accorded a SN, his or her SN will be displayed. The appearance of icon 354 when a call is incoming may be just the presentation of the icon with the ID details/SN, yet other visual attributes may be used to attract the attention of the user, such as the icon will flash or will cyclically change colors, etc. The user of system 201 may accept the call by pressing on icon ‘ACCPT CALL’ 356 or reject the call by pressing on icon ‘RJCT CALL’ 354. According to embodiments of the present invention the user may mark a caller as one that calls from him should always be rejected, for example by pressing on icon ‘RJCT CALL’ 354 repeatedly twice. According to embodiments of the present invention such action may be confirmed by system 201, for example by presenting a confirmation notice on screen 210 for few seconds, or may require a confirmation prior to permanently blocking calls from that caller.

The user may also establish a conference call with the calling member and other phone users by pressing on icon ‘CONF CALL’ 364, which in turn may open in portion 57 of display screen 52 a list of phone users available for the establishment of the call (not shown), from which the user may pick one (or more, depending on the phone conferencing abilities) members/users for connecting them to the call. The user in vehicle 200 may further alert other members currently engaged in ad-hoc network 252 that he/she are in, or about to enter, an emergency situation, by pressing on icon ‘SOS’ 360. This may initiate an immediate call to one or more of emergency services such as the police, fire squad, medical emergency service, and the like. According to some embodiments the transmission to a public emergency service may comprise transmission of momentary location, for example taken from a GPS unit, and/or the VID details. Further, pressing on icon ‘SOS’ 360 will activate transmission to the members that will force presenting an icon representing vehicle 200 on their screens, with indications of direction and distance between vehicle 200 and the respective other vehicle (when available) and a writing that vehicle 200 has transmitted ‘SOS’ indication. According to embodiments of the present invention when indication of distance/direction between vehicle 200 and the respective other vehicle is available system 201 of the respective vehicle will enforce switching to display screen 50 (“Radar” screen”) and then will display the icon of vehicle 200 relatively to the icon of the respective other vehicle, to graphically display to the user the relative position to vehicle 200 who signals ‘SOS’. Based on the ability of system 200 to create or join a network, one can establish an SOS massage on base frequency that will burst to all members that are in a listening radius. For example, the 455 MHz that is in use to transmit SOS massage from ships that are in distress.

In order to control the various functions effecting how information is displayed to the user icons controlling the display modes located in area 55 of display screen 52 may be used. The user may set various display parameters of the “Radar” screen 50 by pressing icon ‘RDR SCREEN SETUP’ 372, which may switch to another display screen (not shown) enabling to set one or more of the following features: enabling/disabling presentation of vehicles traveling the opposite direction; setting the distance at which disconnection of communication within ad-hoc network 252 is expected (as graphically represented by line 320), presenting/removing display of moving map along with other graphical elements; setting mode of displaying of graphical elements in 2D/3D (as is known with many commercially available GPS-based moving maps built into road maps); setting mode of displaying to day/night compatible colors selection, etc. Further, the user may be able to define a group of vehicles, by their VID signs or by their given SN, which will not be presented on the screen unless any one vehicle of this group has been identified as approaching the user's vehicle in risky trajectory, at which situation its graphical presentation will be enforced. Similarly the user will be able to define a group of vehicles that will be presented on the screen whenever their system is engaged in ad-hoc network 252.

According to embodiments of the present invention user of system 201 may further set the parameters of display on the screen via setting functions available via icon ‘USERS DISP SETUP’ 374, which allows defining the ‘black list’ and/or ‘white list’ of vehicles which will never be served/responded by system 201 or that will always be attended to by system 201, respectively. Further setting is available when pressing icon ‘THRESHOLD SETUP’ 376, which allows setting thresholds such as how close can vehicle 200 get to a vehicle in front of it when the “too close” warning is triggered. While the nominal value is commonly set to “the distance vehicle 200 travels in 2 seconds in the current speed”, the user may wish to expand this value in order to get earlier warning. In some embodiments of the invention the warning may be turned ON based not only on the distance but also on the relative direction between the user's vehicle and the other vehicle and further based on the rate of getting close. Another threshold that may be set is the threshold indicating ‘about to be disconnected from ad-hoc network’.

Area 57 of screen display 52 enables the user of system 201 to manage a list of vehicles/users already known and recorded, similarly to the management of a list of contact people in the memory of a phone device. By pressing icon ‘ADD/MOD USERS’ 382 the user may add, edit and remove details of other vehicles, accord them a SN and add a realistic image/photo that will be displayed as an icon of that vehicle when it is presented on the screen. Alternatively, system 201 may store a representative graphical icon for certain car manufacturers or car models, which will be used for presenting the respective vehicle on the display. Via this list it is also possible to add attendees to a conference call. By pressing icon ‘LISTS MANAG’ 384 the user may manage lists, or groups of users/vehicles. For example, managing ‘black lists’ and/or ‘white lists’, as explained above in details.

When the user of system 201 wishes to switch from MENU screen 52 to RADAR screen 50 he/she may press on ‘RADAR SCREEN’ button 361.

It will be apparent to those skilled in the art that the description of the various functionalities and the way of activating them, as described above, relates to an embodiment where display 210 and input means 212 are embodied in one device, such as a touch screen. However, the same or similar arrangement may be utilized when display 210 and input means 212 are embodied separately, to realize the functionalities and operational modes described above without departing from the spirit of the invention.

According to embodiments of the present invention when a vehicle approaches a controlled gate, that gate may be opened for approved vehicles when that vehicle gets close enough, as that vehicle is made known to the controlled gate based on the visible ID signs of the vehicle which may be transmitted to the gate via a temporary wireless ad-hoc network in which both the gate and the approaching vehicle are members.

According to embodiments of the invention operation of the user-system interface may be carried out, fully or partially, using voice commands and voice response, to improve safety of the use of the system.

According to embodiments of the invention the entering of the visible ID signs into the system may be done only by approved services, to prevent fraud.

According to embodiments of the invention system 201 may be used for sending alarm signals when the vehicle is stolen, and may assist in spotting the vehicle when it was stolen.

According to embodiments of the invention when the vehicle is linked to a wireless ad-hoc communication network several data items may be provided to system 201 such as availability of parking spaces, availability of other services, based on the location of the vehicle.

According to embodiments of the present invention system 201 may issue a signal to vehicle 200 that is indicative of a closely upcoming need for braking, for example when vehicle 200 is too close to a vehicle in front of it and is approaching that vehicle with a too high speed. In such situation that signal may be used for lighting the rear brake lights slightly before the driver of vehicle 200 touches the brake pedal (or any other braking means) and thus provide an anticipating signal that may enhance the driving safety.

According to embodiments of the present invention data saved in system 201 that may be of interest to legal authorities, such the police may be made available to these authorities under the local binding laws and regulations pertaining to protection of privacy and possibly other restrictions. According to yet another embodiment system 201 may be programmed to enable a vehicle belonging to an enforcing force, such as police, to initiate a call to system 201 so that the user of system 201 may not reject or block the call. This feature may be useful when a police car is chasing a law-breaking vehicle and it is required to let the user of the chased vehicle to know that he/she are instructed to stop the vehicle and pull over. According to this embodiment memory 221 of system 210 may store a list of such law-enforcing vehicles that are allowed to initiate such a break-through call.

According to embodiments of the present invention system 201 may be set, when vehicle 200 is not in use, to a ‘theft alarm’ mode. When in that mode system 201 may transmit, intermittently, a signal to a receiver next to the owner of vehicle 200. Said signal may be used to identify, for example based on Doppler Effect, movement of vehicle 200 and thus to trigger a theft alarm.

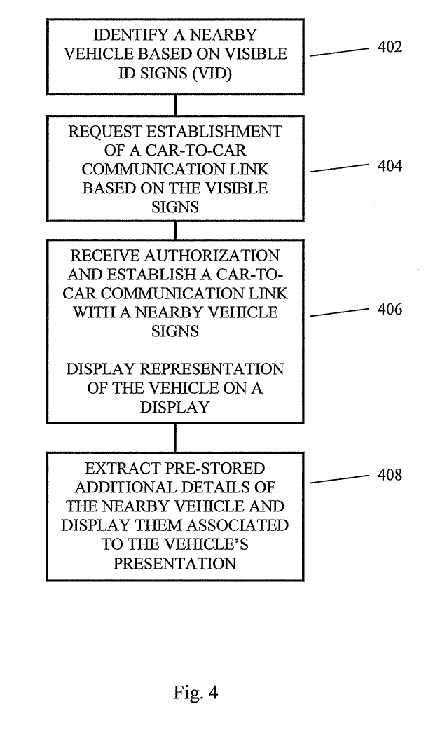

Reference is made now to FIG. 4 which is a schematic flow diagram of a method initiating and maintaining a call with a nearby vehicle based on the visible external ID signs of that vehicle, according to embodiments of the present invention. First, the user identifies a nearby vehicle relying on the VID signs of that vehicle (block 402). Then the user issues a request to establish a car-to-car call to that vehicle (block 404) by sending a call request to that vehicle by means of pressing a button associated with that vehicle in the user's screen area 50A. When an authorization from the called vehicle is received the call takes place and respective indication is displayed on the screen (block 46). Finally when the visible signs of the called vehicle are associated with a SN stored in the calling vehicle system, that SN will be presented next to the graphic (or other) representation of the called vehicle (block 408).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system installed on a vehicle comprising:
a processor comprising;
a memory unit to store a set of visible identification signs associated with said vehicle and calling details for calling said vehicle;
a short range communication unit to enable participation in ad-hoc communication network;
a display unit; and
input means,
wherein said communication unit is adapted to transmit indication of said visible identification signs to other participants in said ad-hoc communication network.

2. The system of claim 1 further comprising mobile phone interface unit to communicate said system with a mobile phone installed in said vehicle.

3. The system of claim 1 further adapted to receive at least one of a list comprising indication of distance of said vehicle from at least one other vehicle and direction from said vehicle to said at least one other vehicle, said direction is relative to the direction of the movement of said vehicle.

4. The system of claim 2 wherein said display unit is adapted to graphically present representation of said vehicle and at least one other vehicle being engaged to said ad-hoc communication network.

5. The system of claim 3 wherein said display unit is adapted to present said at least one other vehicle relatively to said vehicle based on said received distance and/or direction.

6. A method for establishing, by a first vehicle, a spontaneous communication with a nearby second vehicle, comprising:
identifying said nearby second vehicle based on visible identification signs of said nearby second vehicle;
establishing a vehicle-to-vehicle communication with said nearby vehicle via a ad-hoc communication network;
identifying on a display in said first vehicle an icon of a vehicle having indications of same visible identification signs;
initiating a call to said nearby second vehicle by activating a call request by touching said icon on said screen.

7. The method of claim 1 further comprising presenting on said display of said first vehicle a line indicative of a border which if a second vehicle crosses to the side other than that of said first vehicle, said second vehicle is about to be disconnected from said ad-hoc communication network.

8. The method of claim 1 further comprising activating a warning signal when said first vehicle is too close and approaching said nearby vehicle too fast.

9. The method of claim 1 further comprising receiving indication of distance of said vehicle from at least said nearby vehicle and direction from vehicle to said nearby vehicle, said direction is relative to the direction of the movement of said vehicle.

10. The method of claim 1 further comprising presenting on said screen an icon of said first vehicle and of said nearby vehicle so that the distance between said vehicles and the direction between said vehicles on said display is relative to said distance and said direction.
